(19) United States
(12) Patent Application Publication
(10) Pub. No.: US 2025/0153628 A1
(43) Pub. Date: May 15, 2025

(54) MONO-MATERIAL FOOT MAT ATTACHMENT

(71) Applicant: Gottlieb Binder GmbH & Co. KG, Holzgerlingen (DE)

(72) Inventors: Lars HEEPE, Tübingen (DE); Konstantinos POULAKIS, Hildrizhausen (DE)

(73) Assignee: Gottlieb Binder GmbH & Co. KG, Holzgerlingen (DE)

(21) Appl. No.: 18/947,155

(22) Filed: Nov. 14, 2024

(30) Foreign Application Priority Data
Nov. 15, 2023 (DE) 10 2023 211 369.4

(51) Int. Cl. B60N 3/04

(52) U.S. Cl. CPC B60N 3/046

(57) ABSTRACT

A foot mat arrangement has a floor covering with a first hook-and-loop element attached to the floor covering by a form fit, material bond and/or friction fit. The foot mat arrangement additionally includes a foot mat and a second hook-and-loop element, wherein the second hook-and-loop element is at least partially fixed to an underside of the foot mat. The first hook-and-loop element and the second hook-and-loop element form a hook-and-loop connection. At least the floor covering, the first hook-and-loop element, the foot mat and the second hook-and-loop element are made of the same mono-material.

### CROSS REFERENCE TO RELATED APPLICATIONS

Applicant claims priority under 35 U.S.C. § 119 of German Application No. 10 2023 211 369.4 filed Nov. 15, 2023, the disclosure of which is incorporated by reference.

### BACKGROUND OF THE INVENTION

### 1. Field of the Invention

The invention relates to a foot mat arrangement for a vehicle, wherein the foot mat arrangement comprises:
a floor covering;
a first hook-and-loop element that is connected to the floor covering;
a foot mat;
a second hook-and-loop element which is at least partially arranged on an underside of the foot mat;
wherein the second hook-and-loop element is connected to the first hook-and-loop element by a hook-and-loop connection. The invention further relates to a vehicle having such a foot mat arrangement and to a method for manufacturing such a foot mat arrangement.

### 2. Description of the Related Art

DE 10 2013 009 091 A1 discloses a position securing system for a floor covering of a motor vehicle via attachment parts of the floor covering and connecting parts on the floor of the motor vehicle. The floor covering is preferably designed as a rubber mat or textile mat. The connecting parts and attachment parts are preferably made of a thermoplastic and equipped with hooking elements that are made of plastic woven fabric or plastic knitted fabric.

EP 3 003 675 B1 also discloses connecting parts for floor coverings, wherein the connecting parts consist of thermoplastic.

The floor covering arrangements known from the prior art can only be recycled with comparatively high outlay.

### SUMMARY OF THE INVENTION

It is therefore an object of the present invention to provide a foot mat arrangement that can be easily recycled. A further object of the invention is to provide a vehicle comprising such a foot mat arrangement. It is an additional object of the invention to describe a method for manufacturing such a foot mat arrangement.

According to the invention, this object is achieved by a foot mat arrangement-having a floor covering, a first hook-and-loop element that is connected to the floor covering, a foot mat, a second hook-and-loop element which is at least partially arranged on an underside of the foot mat, wherein the second hook-and-loop element is connected to the first hook-and-loop element

The foot mat arrangement according to the invention is characterized in that the floor covering, the first hook-and-loop element, the foot mat and the second hook-and-loop element are made of the same mono-material.

This means that the various components of the foot mat arrangement no longer need to be separated according to their material composition when the foot mat arrangement is recycled. The mono-material of the foot mat arrangement can be reused directly in the context of recycling.

The term mono-material is understood in particular to mean a material which consists of at least 90%, preferably at least 95%, of a single substance. The mono-material comprises in particular at least 90%, preferably at least 95%, particularly preferably at least 99%, of polymers of the same (polymer) group. Preferably, the mono-material is formed of at least 90%, preferably at least 95%, particularly preferably at least 99%, of polymers of the same (polymer) group.

The connection between the floor covering and the first hook-and-loop element is established in particular by a form fit, material bond and/or friction fit.

An embodiment of the foot mat arrangement is preferred in which the mono-material is formed as a polyester, in particular a polylactide, a polypropylene or as a polyamide. In particular, the polymers which the mono-material comprises to an extent of at least 90%, preferably at least 95%, particularly preferably at least 99%, are selected from the group of polyesters, in particular polylactides, polyolefins and/or polyamides. Polyesters can be recycled particularly efficiently chemically and/or mechanically.

An embodiment of the foot mat arrangement is advantageous in which the first hook-and-loop element has a base plate, wherein a counter plate of the foot mat arrangement is arranged at least partially on the floor covering, wherein a connection system connects the base plate and the counter plate to one another, wherein the connection system has an elastic connection device, wherein the connection device extends between mutually facing, in particular mutually parallel, sides of the base plate and the counter plate.

In particular, the connection device is formed on one side of the base plate and one side of the counter plate, wherein these sides face one another and lie opposite one another along a connection system axis perpendicularly through these sides.

The arrangement of the connection device between the base plate and the counter plate means that the foot mat arrangement is designed to save space, wherein the elastic connection device facilitates the installation and removal of the foot mat thanks to its flexible design.

The sides of the base plate and the counter plate, between which the connection device is formed, run in particular parallel or at an acute angle to one another.

The term “side” refers in particular to a side surface. The expression “at least partially” means in particular “partially or completely.”

The base plate and the counter plate can be attached to the floor covering in a space- and material-saving manner by passing the connection system through the access opening and placing it on the floor covering. By connecting the base plate to the floor covering with the help of the counter plate, preferably no recesses or projections in the floor of a motor vehicle are necessary for fastening in order to firmly connect the foot mat to the floor. This allows the foot mat arrangement to be designed flat so that the installation space that is required by the foot mat arrangement is small.

The elastic connection device allows the base plate and the counter plate to be easily connected to one another and/or pressed against the floor covering in order to make the connection between the aforementioned plates and the floor covering more stable.

After fixing the base plate to the counter plate, the foot mat is easily attached by connecting the first hook-and-loop element which has the base plate to the second hook-and-loop element which is arranged on the foot mat. The second hook-and-loop element is preferably firmly connected to the foot mat. The foot mat arrangement can thus be advantageously installed in a space-saving and time-saving manner.

The elastic connection device comprises one elastic component or a plurality of elastic components that are used to connect the counter plate and base plate, such as an elastic connecting web. The elastic connection device preferably comprises a polymer with thermoplastic and/or elastic properties. In particular, the polymer is in the form of a thermoplastic polymer. The elastic connection device typically comprises a polymer from the group of polyesters, polyamides and/or propylenes as material. Preferably, the connection system comprises the polymer which is comprised by the connection device. Typical values of the elastic modulus of the elastic connection device are in the range of 1000 N/mm² to 5000 N/mm², in particular 1300 N/mm² to 2500 N/mm². In particular, the elastic component comprises one of the aforementioned materials and/or elastic moduli. The elastic connection device can have a taper, in particular in portions that pass through the access opening.

The connection system comprises the elastic connection device and may also comprise further elastic and/or non-elastic components which are used to connect the counter plate and base plate. The elastic component of the elastic connection device can have a considerably lower elastic deformability when connected to other components of the connection system than when in a state detached from the rest of the connection system.

The counter plate, the base plate and the elastic connection device, in particular in the form of a connecting web, can be arranged or designed in a U-shape in some embodiments.

In a further development of the aforementioned embodiment, the base plate has a first latching element with a first latching portion, and the counter plate has a second latching element with a second latching portion, wherein the elastic connection device has at least one of the latching elements, wherein the latching portion of the latching element of the elastic connection device is elastically pivotable and/or deformable, wherein the first latching element and the second latching element are latched together with the first latching portion resting on the second latching portion.

The installation of the foot mat on the second hook-and-loop element is advantageously carried out by connecting the first hook-and-loop element to the second hook-and-loop element and simply latching the first hook-and-loop element on the counter plate. Conversely, the foot mat can be removed non-destructively by undoing this latching connection and undoing the hook-and-loop connection without having to undo an integrally bonded connection, such as an adhesive connection, with a comparatively high expenditure of time.

The position designations “above,” “below,” “upper side,” “lower side” and the like used here refer to the installed state of the foot mat arrangement in a vehicle.

An embodiment of the foot mat arrangement is advantageous in which the first latching element together with the base plate of the first hook-and-loop element and/or the second latching element together with the counter plate has an extrusion profile with the respective latching portion, in particular is designed in the form of an extrusion profile. This allows the latching elements to be manufactured particularly cost-effectively and in a time-saving manner. An extrusion profile is understood in particular to be a component with a constant cross-section. The base plate can be formed from the first mono-material.

The first hook-and-loop element may have mushroom-shaped projections that engage with mushroom-shaped projections of the second hook-and-loop element. Alternatively or additionally, the first hook-and-loop element can have hooks, and the second hook-and-loop element can have loops. Preferably, the first hook-and-loop element has loops, and the second hook-and-loop element has hooks so that the floor covering with the first hook-and-loop element has a visually uniform appearance when the foot mat is removed.

The mushroom-shaped projections, hooks and/or loops may be part of a strip. The loops can be provided on a loop strip, and/or the hooks can be provided on a hook strip. In particular, the loops can be formed on a loop strip, and/or the hooks can be formed on a hook strip. The respective strip is preferably glued and/or welded onto an extrusion profile or the foot mat.

An embodiment of the foot mat arrangement is preferred in which the first latching element protrudes from a surface of the first hook-and-loop element in the direction of the counter plate, and/or the second latching element protrudes from a surface of the counter plate in the direction of the first hook-and-loop element. This results in a compact design of the latching connection between the first and second latching elements.

In an advantageous embodiment of the foot mat arrangement, the first latching element and/or the second latching element has a latching arm, wherein the respective latching arm has a stem from which the respective latching portion protrudes. By means of a latching arm with the latching portion, the elastic deflectability and/or deformability of the latching portion can be achieved particularly easily.

In a development of the aforementioned embodiment of the foot mat arrangement, the respective latching element has a plurality of latching arms, in particular two latching arms. Since in this development a plurality of latching arms counteract forces on the foot mat, the individual latching arms can have a lower load capacity than when using only one latching arm of the respective latching element. Therefore, the latching arms can, for example, be designed with a smaller material thickness. This allows the latching arms and thus the foot mat arrangement to be designed particularly flat with a high stability.

In a further embodiment of the foot mat arrangement, the latching portion of the first latching element runs parallel to a side surface of the first hook-and-loop element, and/or the latching portion of the second latching element runs parallel to a side surface of the counter plate, wherein the latching arm protrudes from the respective side surface. This creates a stable latching connection when the latching arms interlock and the latching portions lie against one another.

An embodiment of the foot mat arrangement is advantageous in which a plurality of latching portions, in particular opposite one another, are formed on the respective latching arm. This increases the flexibility in the selection of the latching portions that are latched together.

An embodiment of the foot mat arrangement is preferred in which:
the floor covering has an access opening;
the base plate is at least partially arranged on an upper side of the floor covering;
the counter plate is at least partially arranged on an underside of the floor covering which is opposite the upper side of the floor covering;
the second hook-and-loop element is at least partially arranged on an underside of the foot mat,
wherein the connection system passes through the access opening.

The base plate and the counter plate can be attached to the floor covering in a space- and material-saving manner by passing the connection system through the access opening and placing it on the floor covering. By connecting the base plate to the floor covering with the help of the counter plate, preferably no recesses or projections in the floor of a motor vehicle are necessary for fastening in order to firmly connect the foot mat to the floor. This allows the foot mat arrangement to be designed flat so that the installation space required by the foot mat arrangement is small.

The elastic connection device allows the base plate and the counter plate to be easily connected to one another and/or pressed against the floor covering in order to make the connection between the aforementioned plates and the floor covering more stable.

After fixing the base plate to the counter plate, the foot mat is easily attached by connecting the first hook-and-loop element, which has the base plate, to the second hook-and-loop element, which is arranged on the foot mat. The second hook-and-loop element is preferably firmly connected to the foot mat. The foot mat arrangement can thus be advantageously installed in a space-saving and time-saving manner.

In a development of the aforementioned embodiment of the foot mat arrangement, the at least one latching element of the elastic connection device is introduced into the access opening.

This allows the latching elements to be connected in a particularly space-saving manner.

An embodiment of the foot mat arrangement in which the counter plate is at least partially attached in an integrally bonded manner to the upper side of the floor covering, in particular by glue or a welded connection, is advantageous.

This means that the counter plate is mounted in a particularly stable manner to the floor covering.

In a development of the aforementioned embodiment, the connection device is at least partially formed between the upper side of the floor covering and the underside of the foot mat.

This makes the connection device comparatively easy to access.

An embodiment of the foot mat arrangement is preferred in which the elastic connection device has an elastic film hinge, wherein the elastic film hinge in particular connects the counter plate and the base plate to one another. This means that the first hook-and-loop element and the counter plate are connected to one another in a stable manner, but can be flexibly aligned relative to one another to facilitate the handling of the first hook-and-loop element and the counter plate. The film hinge is preferably made of the mono-material.

In an advantageous embodiment of the foot mat arrangement, the counter plate and/or the first hook-and-loop element has a support projection which protrudes from the respective surface of the counter plate or the first hook-and-loop element. The support projection serves in particular to support the first hook-and-loop element and the counter plate against each other. This better ensures the stability of the position and shape of the first hook-and-loop element and the counter plate in the foot mat arrangement. The support projection is preferably made of the mono-material.

A preferred embodiment of the foot mat arrangement is characterized in that the counter plate is designed with noise protection. This suppresses any noise generated by the counter plate. The noise protection can be in the form of a block, a plurality of blocks and/or a coating. The noise protection can consist of a soft and/or acoustically damping material.

A vehicle according to the invention has an aforementioned foot mat arrangement. In such a vehicle, the foot mat arrangement can be recycled particularly easily.

A method according to the invention for manufacturing a foot mat arrangement for a vehicle, wherein the foot mat arrangement comprises:
a floor covering;
a first hook-and-loop element that is connected to the floor covering;
a foot mat;
a second hook-and-loop element which is at least partially arranged on an underside of the foot mat;
wherein the second hook-and-loop element is connectable to the first hook-and-loop element by a hook-and-loop connection,
wherein the floor covering, the first hook-and-loop element, the foot mat and the second hook-and-loop element are made of the same mono-material, comprises the following step:
connecting the first hook-and-loop element and the second hook-and-loop element.

A foot mat arrangement manufactured by such a method can be easily recycled.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1A shows a schematic sectional view through a foot mat arrangement in a first embodiment, wherein hook-and-loop elements of the foot mat arrangement are separated.

FIG. 1B shows a schematic sectional view through the foot mat arrangement from FIG. 1A, wherein the hook-and-loop elements of the foot mat arrangement are connected.

FIG. 2A shows a schematic sectional view through a floor covering and a counter plate of a foot mat arrangement in a second embodiment.

FIG. 2B shows a schematic plan view of the floor covering and the counter plate from FIG. 2A.

FIG. 2C shows a schematic sectional view through the counter plate, the floor covering and a first hook-and-loop element of the foot mat arrangement in the second embodiment.

FIG. 2D shows a schematic sectional view through the floor covering and the counter plate connected to the first hook-and-loop element according to the second embodiment.

FIG. 2E shows a schematic sectional view through the foot mat arrangement according to the second embodiment before the attachment of a foot mat.

FIG. 2F shows a schematic sectional view through the foot mat arrangement from FIG. 2E in the attached state of the foot mat.

FIG. 3 shows a schematic sectional view through a third embodiment of a foot mat arrangement with a support projection.

FIG. 4 shows a schematic sectional view through a fourth embodiment of a foot mat arrangement with a film hinge.

FIG. 5A shows a schematic sectional view through a further arrangement of a first hook-and-loop element, a counter plate and a floor covering,

FIG. 5B shows a schematic sectional view through a fifth embodiment of a foot mat arrangement, wherein hook-and-loop elements of the foot mat arrangement are separated.

FIG. 5C shows a schematic sectional view through the foot mat arrangement from FIG. 5B, wherein the hook-and-loop elements of the foot mat arrangement are connected.

FIG. 6 shows a schematic side view of a vehicle with a foot mat arrangement according to the invention.

### DETAILED DESCRIPTION OF PREFERRED EMBODIMENTS

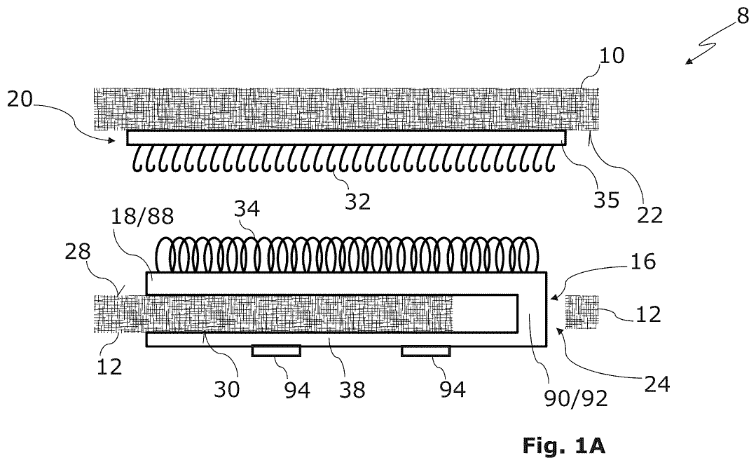

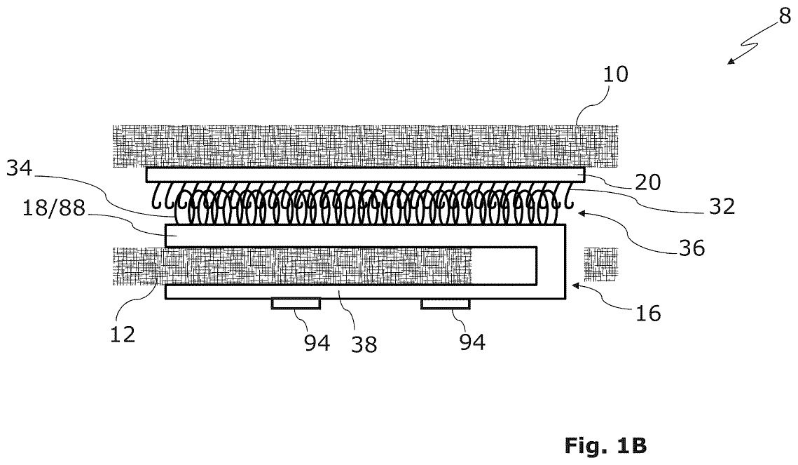

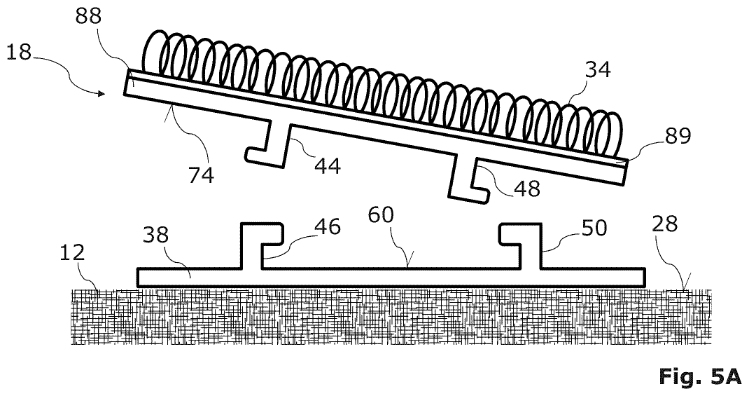

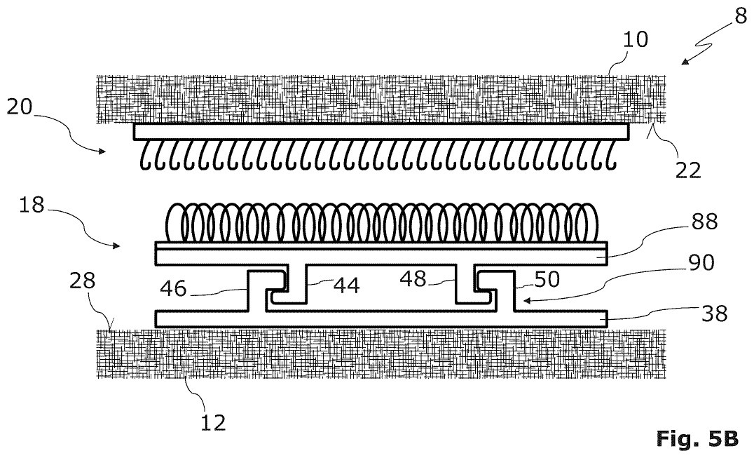

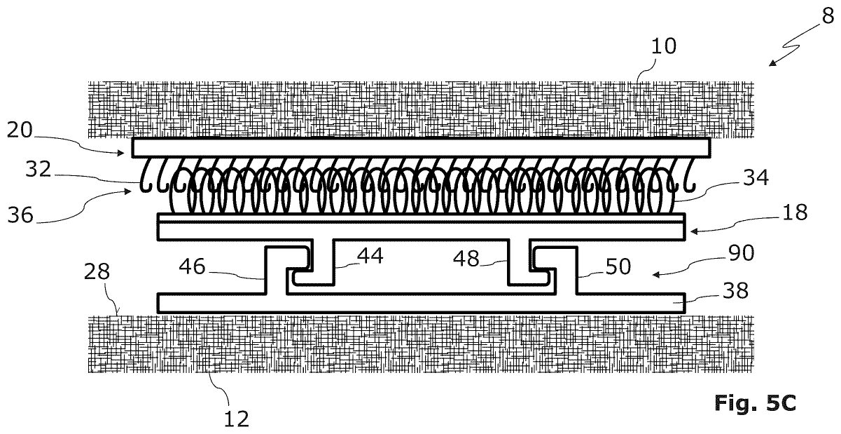

FIG. 1A shows a schematic sectional view through a first embodiment of a foot mat arrangement 8. The foot mat arrangement 8 has a foot mat 10 and a floor covering 12, wherein the floor covering 12 is attached to a floor of a vehicle 14 (see FIG. 5). The foot mat arrangement 8 has a first hook-and-loop element 18 on the floor covering 12, wherein the first hook-and-loop element 18 is arranged with a base plate 88 at least partially on an upper side 28 of the floor covering 12. Furthermore, the foot mat arrangement 8 has a second hook-and-loop element 20 on the underside 22 of the foot mat 10. The second hook-and-loop element 20 is attached to the underside 22 of the foot mat 10, in particular glued or welded on.

A counter plate 38 is on an underside 30 of the floor covering 12. A connection system 16 connects the base plate 88 and the counter plate 38. The connection system 16 has an elastic connection device 90. In the shown embodiment, the elastic connection device 90 is designed in the form of an elastic connecting web 92 which extends through an access opening 24 in the floor covering 12. In this way, the first hook-and-loop element 18 is firmly anchored in the floor covering 12. Noise protection 94 can be located on the counter plate 38.

The first hook-and-loop element 18 is structured in a complementary manner to the second hook-and-loop element 20 such that the first hook-and-loop element 18 and the second hook-and-loop element 20 form a hook-and-loop connection 36 (see FIG. 1B) in order to firmly connect the foot mat 10 to the floor covering 12. In the shown embodiment of the hook-and-loop elements 18, 20, the second hook-and-loop element 20 has hooks 32 and the first hook-and-loop element 18 has loops 34 corresponding to the hooks 32, which makes the hook-and-loop connection 36 of the first hook-and-loop element 18 and the second hook-and-loop element 20 possible. In other embodiments, the first hook-and-loop element 18 may have the hooks 32 and the second hook-and-loop element 20 may have the loops 34. The hooks 32 can be part of a hook strip 35.

The floor covering 12, the first hook-and-loop element 18, the foot mat 10 and the second hook-and-loop element 20 are made of the same mono-material. The mono-material is preferably a polyester, in particular a polylactide, a polypropylene or a polyamide.

FIG. 1B shows a schematic sectional view through the foot mat arrangement 8 with the foot mat 10 and the floor covering 12, wherein the counter plate 38 is fastened to the base plate 88 by the connection system 16. The hook-and-loop elements 18, 20 of the foot mat arrangement 8 form the hook-and-loop connection 36 in that the hooks 32 of the second hook-and-loop element 20 engage in the loops 34 of the first hook-and-loop element 18.

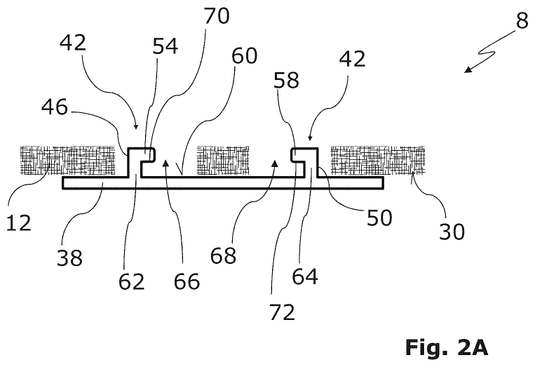

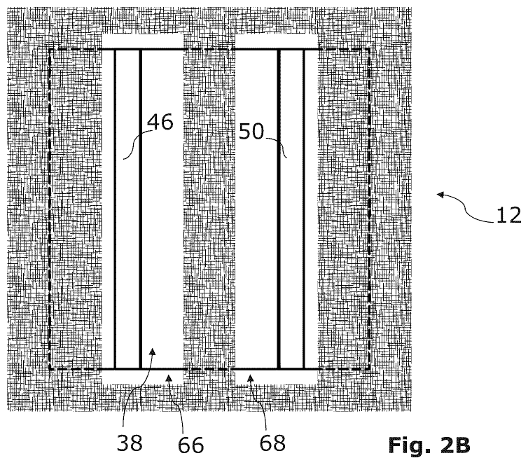

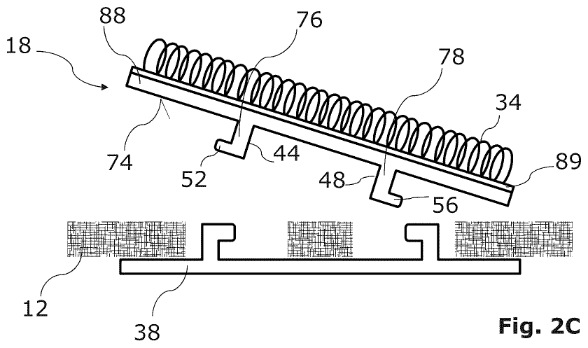

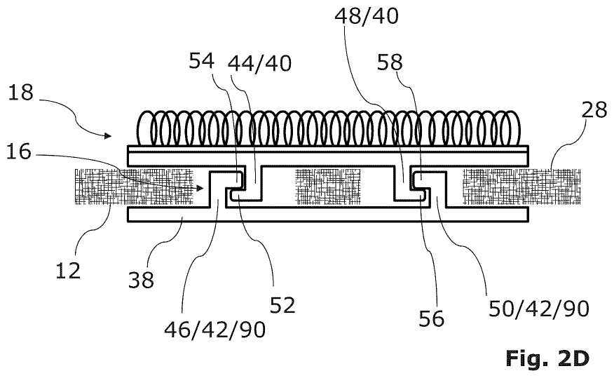

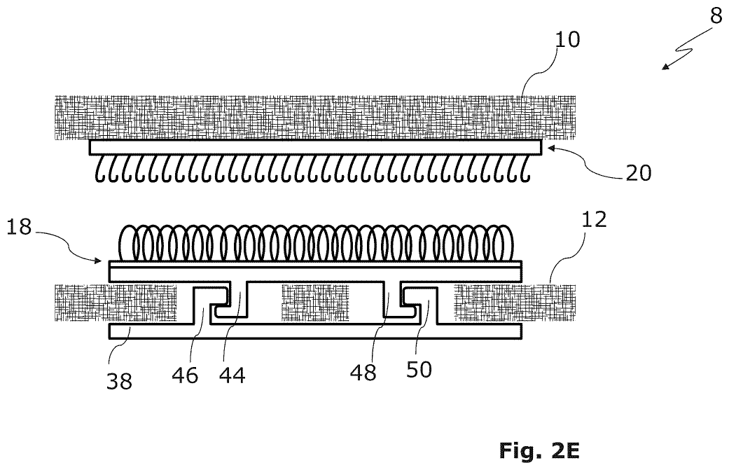

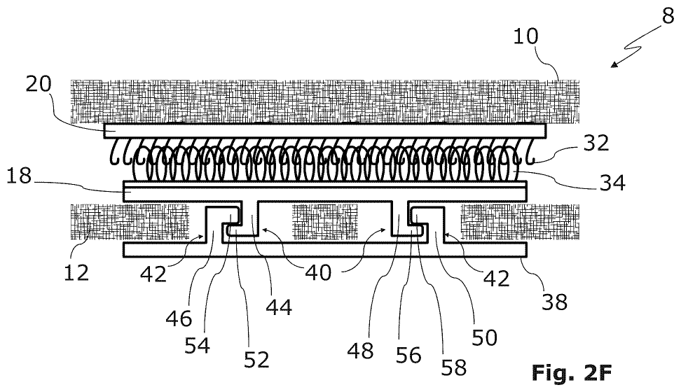

As explained in greater detail below with reference to FIG. 2A to FIG. 2F, the foot mat arrangement 8 may in some embodiments have a first latching element 40 and a second latching element 42, in particular with a first, second, third and fourth latching arm 44, 46, 48, 50 (see FIG. 2F). A first, second, third and fourth latching portion 52, 54, 56, 58 can be formed on the latching arms 44, 46, 48, 50.

FIG. 2A shows a schematic sectional view through a lower part of a foot mat arrangement 8 in a second embodiment. The underside 30 of the floor covering 12 touches the counter plate 38, wherein the counter plate 38 extends along the underside 30 of the floor covering 12. The second latching element 42 is arranged on the upper side 60 of the counter plate 38, wherein the second latching element 42 is formed with the second and fourth latching arms 46, 50 which extend from the upper side 60 of the counter plate 38. From a stem 62, 64 of the respective latching arm 46, 50, the second and fourth latching portions 54, 58 protrude, in particular perpendicularly. The latching portions 54, 58 serve to latch the respective latching arms 46, 50. The latching arms 46, 50 are designed in a hook-like manner by the latching portions 54, 58 and each engage in an access opening 66, 68 of the floor covering 12.

The latching portions 54, 58 preferably run parallel to the upper side 60 of the counter plate 38. In particular, edges 70, 72 of the latching portions 54, 58, which protrude from the respective stem 62, 64 and run to an outer end of the relevant latching portion 54, 58, are aligned parallel to the upper side 60 of the counter plate 38. The latching portions 54, 58 on the latching arms 46, 50 are designed to be elastically pivotable and/or deformable.

FIG. 2B shows a schematic plan view of the floor covering 12 and the associated counter plate 38. Regions of the counter plate 38 which are covered by the floor covering 12 are indicated by dashed lines. Also shown are the latching arms 46, 50 which reach through the access openings 66, 68 of the floor covering 12.

FIG. 2C shows a schematic sectional view through an embodiment of the first hook-and-loop element 18 which is brought to the counter plate 38 and the floor covering 12 (cf. FIG. 2A) in order to be latched to the counter plate 38. From the underside 74 of a base plate 88 of the first hook-and-loop element 18, the first and third latching arms 44, 48 protrude, in particular perpendicularly. The first and third latching portions 52, 56 protrude from the stem 76, 78 of the respective latching arm 44, 48, wherein the latching portions 52, 56 are aligned in particular perpendicular to the relevant stem 76, 78. The latching arms 44, 48 are thus hook-shaped. The latching portions 52, 56 run in particular parallel to the underside 74 of the first hook-and-loop element 18. A loop strip 89 with the loops 34 of the first hook-and-loop element 18 is preferably glued and/or welded to the base plate 88.

FIG. 2D schematically shows a sectional view through the aforementioned embodiment of the first hook-and-loop element 18 which is fastened to the counter plate 38 and rests on the upper side 28 of the floor covering 12. The latching portions 52, 54 of the first and second latching arms 44, 46 as well as the latching portions 56, 58 of the third and fourth latching arms 48, 50 rest against one another, wherein the latching arms 44, 46, 48, 50 engage in such a way that they are latched together. Of the latching portions 52, 54, 56, 58 on the latching arms 44, 46, 48, 50 which are latched together, preferably at least one is elastically pivotable and/or deformable. This allows the latching of the latching arms 44, 46, 48, 50.

By way of example, in the shown embodiment, the latching portions 54, 58 of the latching arms 46, 50 are designed to be elastic. The elastic connection device 90 of the connection system 16 then has the latching arms 46, 50 with the elastic latching portions 54, 58.

The latching arms 44, 46, 48, 50, and thus the latching elements 40, 42, are preferably designed as an extrusion profile or as part of an extrusion profile.

FIG. 2E schematically shows a sectional view through an embodiment of the foot mat arrangement 8 according to the invention. The foot mat arrangement 8 has the foot mat 10, the floor covering 12, the first hook-and-loop element 18 and the second hook-and-loop element 20 as well as the counter plate 38, wherein the counter plate 38 is fastened to the first hook-and-loop element 18 by the latching arms 44, 46, 48, 50.

The first hook-and-loop element 18 is separated from the second hook-and-loop element 20 in the state of the foot mat arrangement 8 shown in FIG. 2E. The first hook-and-loop element 18 is brought to the second hook-and-loop element 20 in order to firmly connect the two hook-and-loop elements 18, 20 to each other and fasten the foot mat 10 to the floor covering 12.

FIG. 2F schematically shows a sectional view through a combined embodiment of the foot mat arrangement 8. The foot mat 10 is firmly connected to the floor covering 12 by the foot mat arrangement 8. The hooks 32 of the second hook-and-loop element 20 engage in the loops 34 of the first hook-and-loop element 18, wherein the first hook-and-loop element 18 is firmly anchored to the floor covering 12 by the latched latching arms 44, 46, 48, 50 and the counter plate 38. This ensures that the foot mat 10 is attached to the floor covering 12 in a non-slip manner. As previously mentioned, the first latching arm 44 has the first latching portion 52, the second latching arm 46 has the second latching portion 54, the third latching arm 48 has the third latching portion 56 and the fourth latching arm 50 has the fourth latching portion 58, wherein the latching portions 52, 54, 56 and 58 rest against one another for latching the latching arms 44, 46, 48 and 50, or the latching arms 44, 46, 48, 50 engage one behind the other.

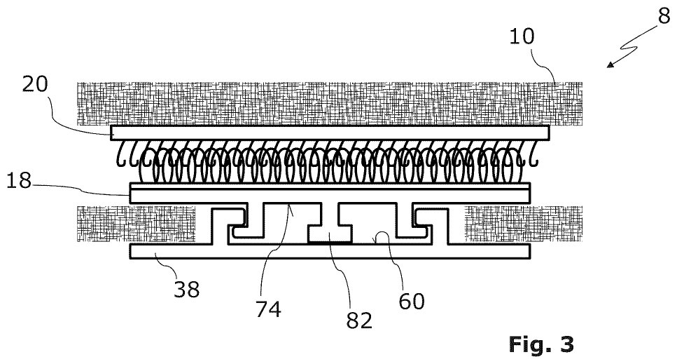

FIG. 3 shows a schematic sectional view through a third embodiment of a foot mat arrangement 8 in which a support projection 82 is formed on the underside 74 of the first hook-and-loop element 18. The support projection 82 is designed here in the shape of an upside-down “T,” wherein the support projection 82 protrudes from the underside 74 of the first hook-and-loop element 18, in particular perpendicularly. The support projection 82 lies flat against the upper side 60 of the counter plate 38 in order to stabilize the first hook-and-loop element 18 in the foot mat arrangement 8.

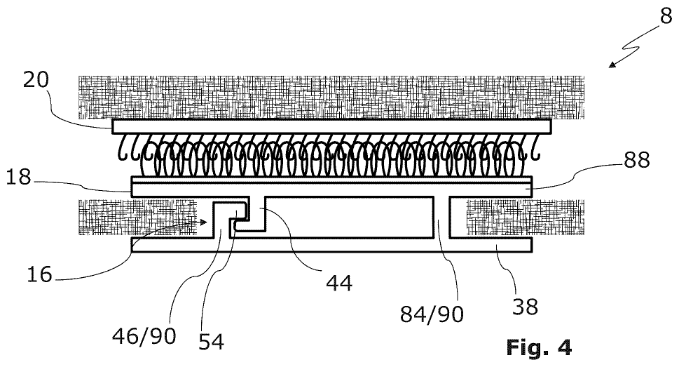

FIG. 4 schematically shows a sectional view through a fourth embodiment of a foot mat arrangement 8, wherein the first hook-and-loop element 18 is designed according to an embodiment in which the first hook-and-loop element 18 only has the first latching arm 44. The counter plate 38 is formed in an embodiment in which the counter plate 38 has only the second latching arm 46. The latching arms 44, 46 engage with one another and are latched together. Furthermore, a film hinge 84 extends from the first hook-and-loop element 18 to the counter plate 38 and connects the first hook-and-loop element 18 and the counter plate 38 in an integrally bonded manner. Preferably, counter plate 38 and base plate 88 are formed in one piece with the film hinge 84. This makes the first hook-and-loop element 18 and the counter plate 38 particularly easy to mount.

By way of example, in the shown embodiment, the latching portion 54 of the latching arm 46 and the film hinge 84 are designed to be elastic. The elastic connection device 90 of the connection system 16 then has the latching arm 46 with the elastic latching portion 54 and the film hinge 84.

FIG. 5A schematically shows a sectional view through a further arrangement of a first hook-and-loop element 18, a counter plate 38 and a floor covering 12, wherein the first hook-and-loop element 18 is brought up to the counter plate 38 and the floor covering 12 in order to be latched with the counter plate 38. The counter plate 38 is fastened to the upper side 28 of the floor covering 12, in particular by means of an integral bond, e.g. with glue or a welded connection. A first and a third latching arm 44, 48 protrude from the underside 74 of the base plate 88 of the first hook-and-loop element 18. A second and a fourth latching arm 46, 50 protrude from the upper side 60 of the counter plate 38. The loop strip 89 with the loops 34 of the first hook-and-loop element 18 is preferably glued and/or welded to the base plate 88.

FIG. 5B shows a schematic sectional view through a fifth embodiment of the foot mat arrangement 8. The foot mat arrangement 8 has a foot mat 10 and the floor covering 12. The foot mat arrangement 8 includes the first hook-and-loop element 18 with the base plate 88 and the counter plate 38 on the upper side 28 of the floor covering 12. The base plate 88 and the counter plate 38 are connected to one another by a connection device 90 in the form of the latched latching arms 44, 46, 48, 50. Furthermore, the foot mat arrangement 8 has the second hook-and-loop element 20 which is attached to the underside 22 of the foot mat 10.

FIG. 5C schematically shows a sectional view through the fifth embodiment of the foot mat arrangement 8, wherein the first hook-and-loop element 18 and the second hook-and-loop element 20 form a hook-and-loop connection 36. The foot mat 10 is firmly connected to the floor covering 12 by the foot mat arrangement 8. The hooks 32 of the second hook-and-loop element 20 engage with the loops 34 of the first hook-and-loop element 18. The first hook-and-loop element 18 is firmly anchored to the upper side 28 of the floor covering 12 by the latched latching arms 44, 46, 48, 50 and the counter plate 38. The counter plate 18 is firmly connected to the floor covering 12 by an integral bond. This ensures that the foot mat 10 is securely attached to the floor covering 12 in a non-slip manner.

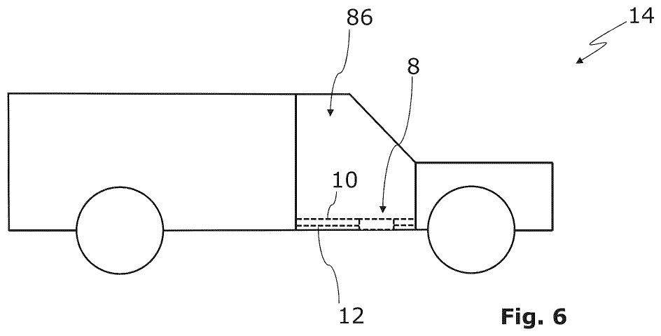

FIG. 6 shows a schematic side view of a vehicle 14 with a foot mat arrangement 8 according to the invention according to one of the aforementioned embodiments. The foot mat arrangement 8 with the floor covering 12 firmly arranged in the vehicle 14 and the foot mat 10 in a driver's compartment 86 are shown in dashed lines in FIG. 6.

Taking an overview of all the figures of the drawing, the invention relates in summary to a foot mat arrangement 8 comprising a floor mat 12. A first hook-and-loop element 18 is attached to the floor covering 12 by a form fit, material bond and/or friction fit. The foot mat arrangement 8 additionally comprises a foot mat 10 and a second hook-and-loop element 20, wherein the second hook-and-loop element 20 is at least partially fixed to an underside 22 of the foot mat 10. The first hook-and-loop element 18 and the second hook-and-loop element 20 form a hook-and-loop connection 36. At least the floor covering 12, the first hook-and-loop element 18, the foot mat 10 and the second hook-and-loop element 20 consist of the same mono-material.

Although only a few embodiments of the present invention have been shown and described, it is to be understood that many changes and modifications may be made thereunto without departing from the spirit and scope of the invention.

### LIST OF REFERENCE SIGNS

8 Foot mat arrangement
10 Foot mat
12 Floor covering
14 Vehicle
16 Connection system
18 First hook-and-loop element
20 Second hook-and-loop element
22 Underside of the foot mat
24 Access opening
28 Upper side of the floor covering
30 Underside of the floor covering
32 Hooks
34 Loops
35 Hook strip
36 Hook-and-loop connection
38 Counter plate
40 First latching element
42 Second latching element
44 First latching arm
46 Second latching arm
48 Third latching arm
50 Fourth latching arm
52 First latching portion
54 Second latching portion
56 Third latching portion
58 Fourth latching portion
60 Upper side of the counter plate
62 Stem of the second latching arm
64 Stem of the fourth latching arm
66 Access opening
68 Access opening
70 Edge of the latching portion
72 Edge of the latching portion
74 Underside of the first hook-and-loop element
76 Stem of the first latching arm
78 Stem of the second latching arm
82 Support projection
84 Film hinge
86 Driver's compartment
88 Base plate of the first hook-and-loop element
89 Loop strip
90 Connection device
92 Connecting web
94 Noise protection

What is claimed is:

1. A foot mat arrangement (8) for a vehicle (14), the foot mat arrangement (8) comprising:
a floor covering (12);
a first hook-and-loop element (18) that is connected to the floor covering (12);
a foot mat (10);
a second hook-and-loop element (20) which is at least partially arranged on an underside (22) of the foot mat (10);
wherein the second hook-and-loop element (20) is connected to the first hook-and-loop element (18) by a hook-and-loop connection (36),
wherein
the floor covering (12), the first hook-and-loop element (18), the foot mat (10) and the second hook-and-loop element (20) are made of the same mono-material.

2. The foot mat arrangement according to claim 1, wherein the mono-material is formed as a polyester.

3. The foot mat arrangement according to claim 1,
wherein the first hook-and-loop element (18) has a base plate (88),
wherein a counter plate (38) of the foot mat arrangement (8) is at least partially arranged on the floor covering (12),
wherein a connection system (16) connects the base plate (88) and the counter plate (38) to one another,
wherein the connection system (16) has an elastic connection device (90), and
wherein the connection device (90) extends between mutually facing sides (60, 74) of the base plate (88) and the counter plate (38).

4. The foot mat arrangement according to claim 3, wherein the base plate (88) has a first latching element (40) with a first latching portion (52), and the counter plate (38) has a second latching element (42) with a second latching portion (54), wherein the elastic connection device (90) has at least one of the latching elements (40, 42), wherein the latching portion (52, 54) of the latching element (40, 42) of the elastic connection device (90) is elastically pivotable and/or deformable, and wherein the first latching element (40) and the second latching element (42) are latched together with the first latching portion (52) resting on the second latching portion (54).

5. The foot mat arrangement according to claim 4, wherein the first latching element (40) together with the base plate (88) of the first hook-and-loop element (18) and/or the second latching element (42) together with the counter plate (38) is in the form of an extrusion profile with the respective latching portion (52, 54).

6. The foot mat arrangement according to claim 4, wherein the first latching element (40) protrudes from a surface of the first hook-and-loop element (18) in the direction of the counter plate (38), and/or the second latching element (42) protrudes from a surface of the counter plate (38) in the direction of the first hook-and-loop element (18).

7. The foot mat arrangement according to claim 4, wherein the first latching element (40) and/or the second latching element (42) has/have a latching arm (44, 46, 48, 50), wherein the respective latching arm (44, 46, 48, 50) has a stem (62, 64, 76, 78) from which the respective latching portion (52, 54, 56, 58) protrudes.

8. The foot mat arrangement according to claim 7, wherein the respective latching element (40, 42) has a plurality of latching arms (44, 46, 48, 50).

9. The foot mat arrangement according to claim 7, wherein the latching portion (52, 54, 56, 58) of the first latching element (40) runs parallel to a side surface (74) of the first hook-and-loop element (18), and/or the latching portion (52, 54, 56, 58) of the second latching element (42) runs parallel to a side surface (60) of the counter plate (38), wherein the latching arm (44, 46, 48, 50) protrudes from the respective side surface (60, 74).

10. The foot mat arrangement according to claim 7, wherein a plurality of latching portions (52, 54, 56, 58) are formed on the respective latching arm (44, 46, 48, 50).

11. The foot mat arrangement according to claim 1,
wherein the floor covering (12) has an access opening (24, 66, 68),
the base plate (88) is at least partially arranged on an upper side (28) of the floor covering (12),
the counter plate (38) is at least partially arranged on an underside (30) of the floor covering (12),
wherein the underside (30) of the floor covering (12) is opposite the upper side (28) of the floor covering (12),
wherein the second hook-and-loop element (20) is at least partially arranged on an underside (22) of the foot mat (10), and
wherein the connection system (16) passes through the access opening (24, 66, 68).

12. The foot mat arrangement according to claim 11, wherein the at least one latching element (40, 42) of the elastic connection device (90) is inserted into the access opening (24, 66, 68).

13. The foot mat arrangement according to claim 3, wherein the counter plate (38) is at least partially attached to the upper side (28) of the floor covering (12) in an integrally bonded manner.

14. The foot mat arrangement according to claim 13, wherein the connection device (90) is at least partially formed between the upper side (28) of the floor covering (12) and the underside (22) of the foot mat (10).

15. The foot mat arrangement according to claim 3, wherein the elastic connection device (90) has an elastic film hinge (84), and wherein the elastic film hinge (84) connects the counter plate (38) and the base plate (88) to one another.

16. The foot mat arrangement according to claim 3, wherein the counter plate (38) and/or the first hook-and-loop element (18) has a support projection (82) which protrudes from the respective surface (60, 74) of the counter plate (38) or the first hook-and-loop element (18).

17. The foot mat arrangement according to claim 3, wherein the counter plate (38) is formed with noise protection (94).

18. A vehicle (14) having the foot mat arrangement (8) according to claim 1.

19. A method for manufacturing a foot mat arrangement (8) for a vehicle (14), wherein the foot mat arrangement (8) has the following:
a floor covering (24, 66, 68);
a first hook-and-loop element (18) that is connected to the floor covering (12);
a foot mat (10);
a second hook-and-loop element (20) which is at least partially arranged on an underside (22) of the foot mat (10);
wherein the second hook-and-loop element (20) is connectable to the first hook-and-loop element (18) by a hook-and-loop connection (36),
wherein the floor covering (12), the first hook-and-loop element (18), the foot mat (10) and the second hook-and-loop element (20) are made of the same mono-material, said method comprising the step of:
connecting the first hook-and-loop element (18) and the second hook-and-loop element (20).
